(19) United States
(12) Patent Application Publication
(10) Pub. No.: US 2016/0180751 A1
(43) Pub. Date: Jun. 23, 2016

(54) METHOD TO PRODUCE A CANVAS GALLERY WRAP

(71) Applicant: Jeffrey A. Podergois, Chanhassen, MN (US)

(72) Inventor: Jeffrey A. Podergois, Chanhassen, MN (US)

(21) Appl. No.: 14/950,021

(22) Filed: Nov. 24, 2015

Related U.S. Application Data
(60) Provisional application No. 62/092,884, filed on Dec. 17, 2014.

(51) Int. Cl. G09F 15/00

(52) U.S. Cl. CPC G09F 15/0025

(57) ABSTRACT

The invention combines canvas with recycled wood fiber base to make a sheet stock that is easily foldable and does not break at the folds. This allows the blank to be run through a printer to have graphics applied to both the front and the sides of the final canvas gallery wrap.

### CROSS-REFERENCE TO RELATED APPLICATIONS

This application claims priority to U.S. Provisional Patent Application Ser. No. 62/092884, filed Dec. 17, 2014, which is incorporated herein by reference in its entirety.

### STATEMENT REGARDING FEDERALLY SPONSORED RESEARCH OR DEVELOPMENT

Not Applicable.

### BACKGROUND OF THE INVENTION

This invention relates to gallery wraps is the stretching of an artist's art such that it wraps around the sides of a wood frame known as stretcher or strainer bars. The canvas is secured to the back of the wooden frame and then may be hung on a wall.

A cardboard approach is shown in U.S. Pat. No. 4,870,766 to Topping in which a cardboard blank has numerous folds and slits which may be bent to create a picture support without the need for wood frames.

The canvas can be blank, printed or painted. It is then stretched over a wood frame and wrapped around the back and secured with staples or tacks. The corners are folded in a pleasing manner. There are specific methods for folding corners, which requires some degree of skill. The canvas wraps around the sides of the underlying wood structure and the image is visible on the sides.

This method has been used for thousands of years. It consists of two elements, the canvas and the frame. The canvas when apart from the frame can be painted or printed. A digital roll printer is a common modern method for printing canvas as the material is thin and can be fed through the printer. The finished product would then be mounted to the frame creating a traditional Canvas Gallery Wrap.

With the advent of flatbed printers a pre-assembled blank Gallery Wrap of varying thickness can be placed directly on the print bed and the printer can image onto the face of the assembled Gallery Wrap. The drawback to this method is the printer cannot print the sides of the Gallery Wrap. This leaves the sides white. A common solution for this is to paint the sides a solid color in a separate step to cover the undesirable white. This is time consuming and a print can be ruined if the paint from the sides is not applied perfectly.

The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 C.F.R. §1.56(a) exists.

### BRIEF SUMMARY OF THE INVENTION

The invention is an improvement to the traditional Gallery Wrap. The invention does not require a wood frame. This saves assembly time, weight, and materials. Since no wood frame is used it is environmentally friendly.

The invention combines canvas with a recycled wood fiber base to give it foldable properties. The canvas is coated to make it compatible with printer inks.

The material is then die-cut and scored into the desired size and shape while remaining in sheet form. This method allows the invention to be a flat sheet during the imaging process. A flatbed or hybrid printer can now image the sides during the print process. The invention is held in a carrier sheet with nicks. The carrier sheet protects the printer bed from ink over printing. The invention is then removed from the carrier sheet and the carrier sheet is discarded.

Once printed the invention folds into a Canvas Gallery Wrap without tools, staples, tacks, adhesives or glue. Tab and slot method is used to secure assembly. The invention is essentially a “flattened” Canvas Gallery Wrap.

The canvas layer prevents cracking on the scores when folding the material. Canvas is a woven material with outstanding folding properties. Without the integrated canvas the wood fibers would crack giving an unsightly appearance. The integrated canvas is essential to the invention.

### BRIEF DESCRIPTION OF THE DRAWINGS

A detailed description of the invention is hereafter described with specific reference being made to the drawings in which:

FIG. 1 is a top view of the canvas gallery wrap blank;

FIG. 2 is a side view of the canvas gallery wrap blank;

FIG. 3 is a perspective view of an assembled canvas gallery wrap;

FIG. 4 is a perspective view of an assembled cardboard gallery wrap;

FIG. 5 is a perspective view from the back of the canvas gallery wrap being assembled; and

FIG. 6 is a perspective view of the back of the fully assembled canvas gallery wrap.

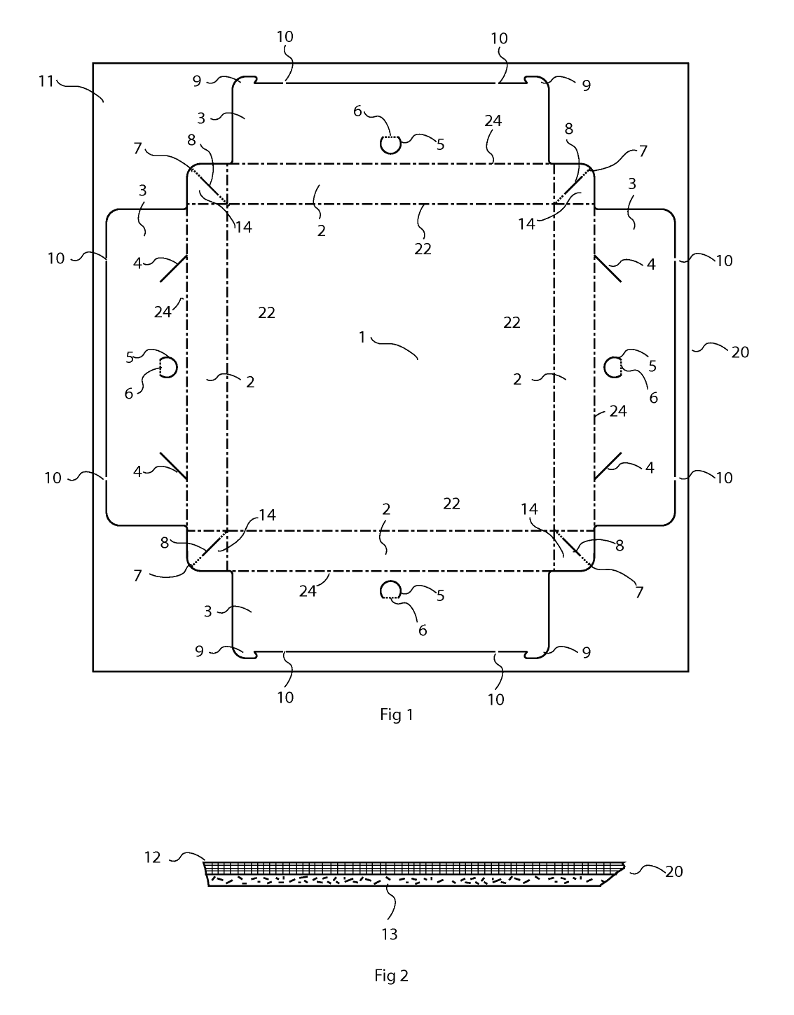

### DETAILED DESCRIPTION OF THE INVENTION

The invention creates a canvas gallery wrap 20 formed from a blank of a wood fiber base 13 such as wood pulp board to which canvas 12 is attached. Wood pulp board and wood fiber base includes cardboard as that is known in the art. The canvas may be attached to the wood fiber base by a water based adhesive. It then goes through a heat process to cure and is nip rolled onto the board. The canvas gives the material good folding properties. The canvas may then be coated to make it more compatible with printer inks, which coatings are well known in the art. For example, the coating may be an acrylic coating pigmented with titanium dioxide to provide a white appearance.

The material is then die-cut and scored into the desired size and shape while remaining in sheet form as shown in FIG. 1. As shown, the completed gallery wrap 20 includes a front face region 1, sides 2, back flaps 3, slots 4, hole flaps 5, hole flap score lines 6 and corner scores 7 and corner cuts 8. It also includes tabs 9 and nicks 10 which keeps the gallery wrap 20 temporarily attached to the carrier sheet 11. The carrier sheet 11 protects the printer bed from ink overprinting. The gallery wrap 20 is then removed from the carrier sheet 11 and the carrier sheet may be discarded or recycled.

Once printed, the gallery wrap 20 is folded into the completed canvas gallery wrap 20 as shown in FIG. 3 without the need for tools, staples, tacks, adhesives or glues. The tab and slot method is uses to secure the sides together and form the gallery wrap. The gallery wrap before folding and securing is essentially a “flattened” canvas gallery wrap.

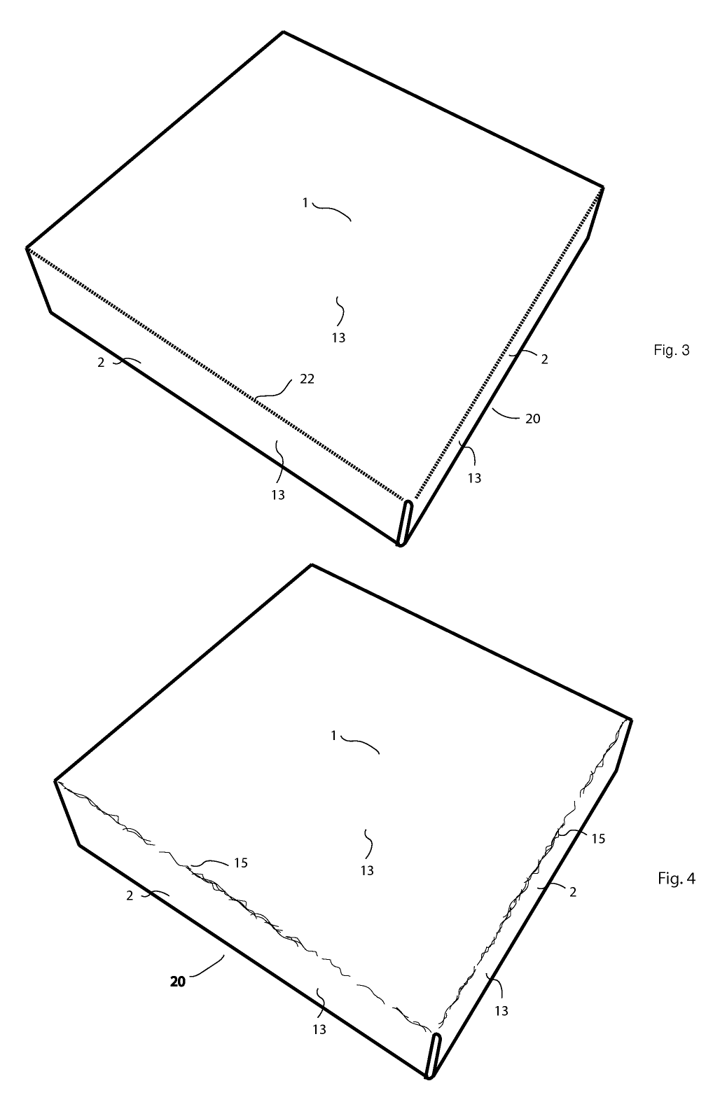

The canvas layer 12 prevents cracking along the score lines when folding the material. With prior art cardboard alternatives, on folding the edges may break as shown in FIG. 4 as reference numeral 15 to show that the print will be marred as the cardboard folds and breaks along the fold lines.

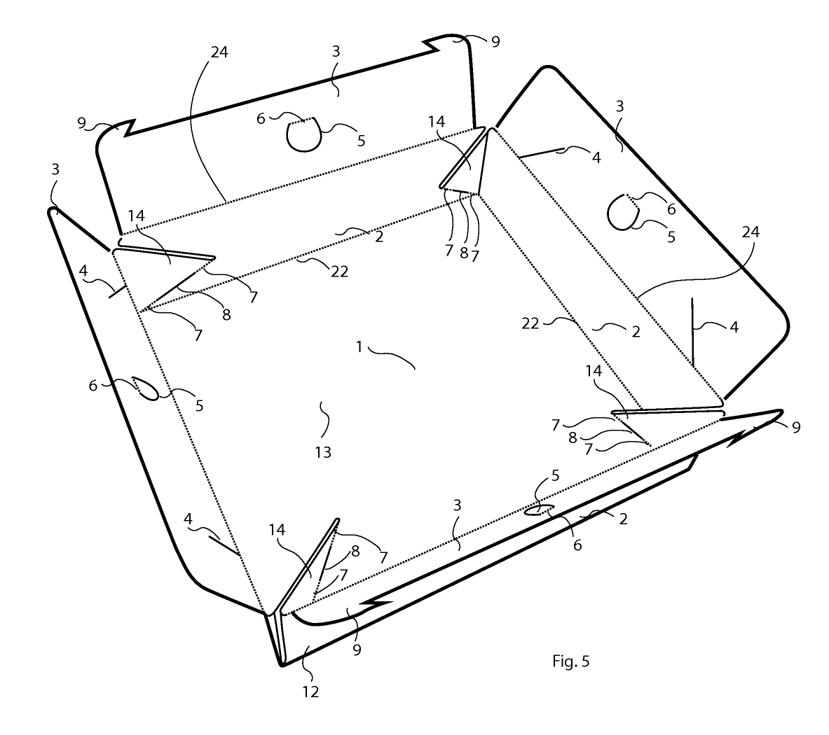

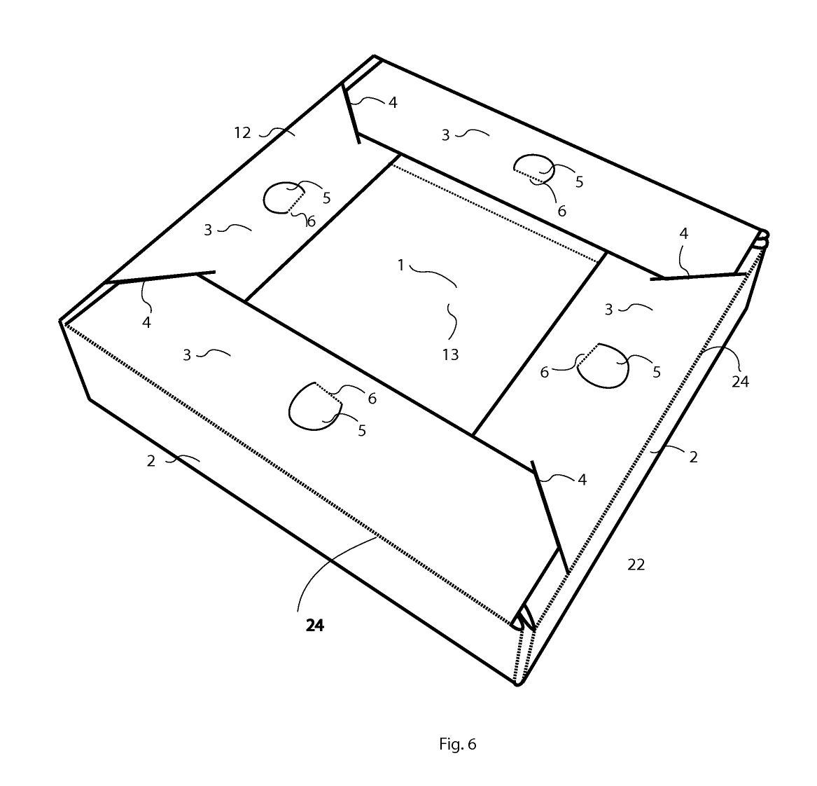

FIG. 5 shows the assembly of the canvas gallery wrap 20 with the front face 1 being defined as the four fold lines 22 are folded as shown. The corner flaps 14 are folded inward with the corner score 7 forming a bend line and the corner cut 8 allowing the material to bend sharply.

FIG. 6 shows the assembled canvas gallery wrap 20 with tabs 9 inserted into slots 4. The tabs 9 as shown may have a hook effect on their end such that once inserted into slot 4 they do not readily come out without manipulation by a user. Note that as shown, the canvas gallery wrap has four hole flaps 5 with a score line 6. The four fold lines 24 complete the back side of the canvas gallery wrap 20 as shown.

The invention requires no skill to produce perfect, consistent corners. The corners have a cut score at a 45-degree angle. The cut does not extend to the end of the corner; the remainder is a folding score. This allows the two halves of the corners to fold in at the same rate with ease, but still remain connected. This connection at the end of the corner keeps the flaps from getting out of alignment as the assembly is folded, creating a perfect corner. The corner flaps are automatically aligned at a 45-degree angle inside the assembly providing support in all four corners from crushing.

The invention has hang flaps on all four axes. These flaps bend-in to receive a hanging method such as a nail, screw or similar method. The flap is cut in a horseshoe shape with a score at the bottom. This configuration is used, as it is not desirable to have a hole while the invention is on the printer. If a hole is used the material will be missing therefore ink will transfer to the printer bed.

The invention saves space, 30 of the inventive canvas gallery wraps 20 have the same depth as one 1.5″ traditional Gallery Wrap. This reduces shipping costs and storage space.

The invention is intended for flatbed printers and hybrid printers (accept both roll and rigid materials), as the thickness of the material is not an issue. The invention cannot be used with standard roll printers, as it is too thick to feed through the machine.

In the case of an artist painting a pre-assembled blank Canvas Gallery Wrap the artist has to paint the front surface and 4 sides. As the artist paints around the sides, the image can be inconsistent as the change in planes interferes with the continuation of the painting strokes.

The invention solves this issue as the canvas is in flat sheet form when painted. This allows the artist to paint on a single plane. The artist can see the score lines so they know when they are painting the front face or the sides. Once the painting is complete the invention is simply folded to its final Canvas Gallery Wrap form. The artist does not have to create a wood frame and mount the canvas.

The finished invention assembly exactly duplicates the look of the traditional Canvas Gallery Wrap, sans the wood frame and difficult assembly process.

While this invention may be embodied in many different forms, there are shown in the drawings and described in detail herein specific preferred embodiments of the invention. The present disclosure is an exemplification of the principles of the invention and is not intended to limit the invention to the particular embodiments illustrated.

1. A method for forming a gallery wrap comprising the steps of:
a) forming a carrier sheet of wood pulp board on one side and canvas on another side;
b) forming a plurality of score lines, fold lines and cuts on said carrier sheet to define a canvas gallery wrap blank once separated from the remainder of said carrier sheet;
c) printing or painting on the canvas of said canvas gallery wrap blank while still attached to said carrier sheet;
d) separating said canvas gallery wrap blank from said carrier sheet; and
e) folding said canvas gallery wrap blank along the score and fold lines to form a completed canvas gallery wrap.

2. The method of claim 1 wherein said canvas gallery wrap blank is scored to include at least one hole flap through which the completed canvas gallery wrap may be hung on a wall.

3. The method of claim 1 wherein said canvas surface is coated with a material to enhance the printability of said canvas in a printer.

4. A canvas gallery wrap comprising a sheet of wood pulp board to which a canvas is attached to at least one side, said canvas gallery wrap further comprising:
a) a rectangular front face having four edges defined by first fold lines;
b) said sheet further defining a second, larger rectangular area beyond the rectangular front face with four edges defined by second fold lines spaced from said first fold lines to form side walls of said canvas gallery wrap;
c) said second rectangular area including four corners defined by said second fold lines and each corner including corner cut lines diagonally from adjacent each corner;
d) each said side wall including a back flap having four edges with an edge connected to said side wall along a fold line;
e) two opposing back flaps each including a pair of spaced tabs at ends of said edges opposite said edge connected to said side wall; and
f) two opposing back flaps each including a pair of slots cut through the canvas and wood pulp board from said fold lines defining the edge of said side walls.
